(19) United States
(12) Patent Application Publication
(10) Pub. No.: US 2009/0027498 A1
(43) Pub. Date: Jan. 29, 2009

(54) SECURITY CLOCK DEVICE AND SYSTEM

(75) Inventors: James E. Owen, Smyrna, GA (US); Ellery W. Potash, Marietta, GA (US)

Correspondence Address: GEORGE R. REARDON, 3356 STATION COURT, LAWRENCVILLE, GA, 30044, US

(73) Assignee: LATHEM TIME, Atlanta, GA (US)

(21) Appl. No.: 11/829,626

(22) Filed: Jul. 27, 2007

(51) Int. Cl. H04N 7/18

(52) U.S. Cl. 348/151; 348/E07.085

(57) ABSTRACT

A discrete or covert surveillance-communication device and system is disclosed that includes at least one miniature video surveillance camera and alerting-communication assemblies hidden in objects resembling office, commercial or household devices, such as a wall clock.

### FIELD OF THE INVENTION

The technology described herein relates to the field of discrete or covert surveillance-communication devices and systems, and more particularly to such discrete devices and systems that include at least one miniature video surveillance camera and alerting-communication assemblies hidden in objects resembling office, commercial or household devices.

### BACKGROUND OF THE INVENTION

Surveillance products incorporating miniature cameras have proliferated in recent years. Miniature cameras can now be hidden in numerous locations such as in pocketbooks, behind walls, in ceilings and within ordinary objects. Many industries today use hidden cameras as an additional security measure in order to protect their inventory, premises and customers. For instance, financial institutions such as banks use hidden surveillance cameras to offer additional protection to their customers and to help guard against theft. Hidden video cameras are also being used more frequently in the home for the protection of children and personal property.

While it is oftentimes desirable to mount surveillance or closed circuit cameras in visible locations to create awareness that an area is being observed, it is also desirable in many situations to use hidden or discrete surveillance cameras. Such discrete surveillance cameras can be located almost anywhere in a room, e.g., in a speaker, in an exit sign, in the ceiling, in a smoke detector. In addition to discrete surveillance, additional alerting and/or communication capabilities are also needed.

Tragic events have created an increasing need for enhancing security within a classroom and at other places where people gather. Post-analysis of these events suggest that the incidents may have been resolved sooner if authorities had real-time intelligence regarding the specific whereabouts of assailants and their hostages or victims. In addition lives could have been saved if those in the advancing path of assailants could have been forewarned; allowing them to lock or barricade their areas, or to escape.

To provide improved safety and security to both students and staff in educational and other public settings, two discrete methods must be simultaneously employed:

1) Provide covert means for remote audio and visual monitoring of areas/rooms which may be proximal to the occurrence of a security event in real-time, and

2) Provide means by which visual alerts and audio/voice commands may be transmitted and annunciated from a central control facility into affected classrooms/areas.

To be effective, these in-situ devices/systems should be positioned at the front of a classroom, or at a position offering direct exposure and advantageous access to the population. To be covert, these facilities must be integrated into common-place fixtures that the population would not feel uncomfortable about, or that a terrorist would not suspect is being used to monitor his activities.

There is a long standing need to provide an integrated solution to the problems and situations described above. Past attempts at solutions by others include cobbled together obvious systems involving closed-circuit Television (CCTV) Cameras, public address speakers, and intercom systems that require persons to stand by the microphone/speaker panel and hold a button to communicate, which is not very practical during an emergency or terror attack.

U.S. patents directed to covert surveillance include the following:
U.S. Pat. No. 6,249,310 B1, issued to Lefkowitz on Jun. 19, 2001, discloses a discrete surveillance device for observing a surveillance location has a housing formed in the shape of a smoke detector and multiple miniature video surveillance cameras mounted within the housing to simultaneously observe multiple areas of the surveillance location. The surveillance cameras are concealed in the housing from an observer viewing the exterior of the housing.

While this patent and other previous methods have attempted to solve the problems that they addressed, none have utilized or disclosed a multi-alerting and communication security platform and system, as do embodiments of the technology described herein.

Therefore, a need exists for a solution to the above problems. The attributes and functionalities of the technology described herein provide this solution. The security platform and system according to embodiments of the invention substantially departs from the conventional concepts and designs of the prior art. It can be appreciated that there exists a continuing need for a new and improved security platform and system which can be used commercially. In this regard, the technology described herein substantially fulfills these objectives.

The foregoing information reflects the state of the art of which the inventors are aware and is tendered with a view toward discharging the inventors' acknowledged duty of candor in disclosing information that may be pertinent to the patentability of the technology described herein. It is respectfully stipulated, however, that the foregoing information do not teach or render obvious, singly or when considered in combination, the inventors' claimed invention.

### BRIEF SUMMARY OF THE INVENTION

The general purpose of the technology described herein, which will be described subsequently in greater detail, is to provide a security platform directed to a multi-alerting and communication security device disguised as a wall clock and a corresponding support system thereof.

The technology described herein pertains to a device having the appearance of a clock, e.g. a wall clock, for use in a classroom and other group settings that includes and implements safety and security functions in addition to the standard timekeeping application of such clocks. The clock face may be an analog or digital type. Bidirectional communication between the clock and a central monitoring and control facility is accomplished using computer networking infrastructure and protocols. This integrated system provides means to covertly monitor (audio and video) the area of installation from a remote location, and to provide audio and visual communications from a central control site (security office) into the crisis area.

In one aspect the technology described herein integrates elements to comprise a comprehensive in-situ security platform within an enclosure whose outward appearance would suggest nothing more than a common wall clock. This platform enables covert surveillance of the monitored area during crisis incidents, such as a terrorist attack. Concealment of its capabilities would make it unlikely that terrorists would target the platform for destruction. In this embodiment the clock device may be either an analog or digital clock and is ordinary in appearance to an outside observer. This clock device may be synchronized to a master clock whose accuracy is traceable to the National Institute of Standards and Technology (NIST), using wired or wireless infrastructure common to computer networks and communication protocols made standard by the Institute of Electrical and Electronics Engineers (IEEE) under their IEEE 802.xx family of specifications. School systems, airports, hospital campuses and factories all rely upon synchronized clock systems to ensure the accuracy of timekeeping and proper synchronization with other time-related systems (security, payroll, etc.).

A video capturing element, e.g. a camera, hidden within the clock device is unlikely to attract attention, as opposed to an obvious CCTV camera that a criminal/terrorist/vandal is apt to disable, destroy or steal. Likewise the general populace who may be the subject of surveillance activities will not feel uncomfortable being spied upon as would be the case of when a camera is obvious.

Using digital processes the camera's image can be transmitted to a central monitoring facility using corresponding data communications infrastructure. This approach reduces installation costs since it reduces the need for placing and wiring video cable, video amplifier and switching equipment. In one aspect the security platform may have a image recognition element to recognize selected images, e.g. a weapon.

In addition to the video image, a sound capturing element, e.g. a microphone, hidden within the security platform allows for the monitoring and transmission of speech and other sounds within the surveillance area. The sound may be digitized for transmission to a central monitoring facility. No intercom-type wiring needs to be pulled and installed, since the audio signal is carried over the network protocol. In one aspect the security platform may have a sound recognition element to recognize selected sounds, e.g. gun fire, screams, explosions, which triggers an alert to the central monitoring system.

To facilitate the providing of alerts from the central security facility to personnel in the crisis areas, as well as to provide a means of negotiating with a criminal suspect, the security platform may include an audio transmission element, e.g. a speaker, either internal to the clock or external and in communication with the security platform. In these embodiments security personnel can speak to assailants, hostages, or persons in the path of a crisis and be heard through the speaker. This communication may also be digitized and carried over the network protocol.

In one embodiment a visual alerting element, e.g. one or more strobe lights (which may be integrated within the security platform or may be external and in communication with the security platform) may be activated from the central security office. This element can provide a non-audible alert to protected personnel, which would not be noticed by criminals in nearby, but out-of-site locations. Such an indicator would also be useful to those persons who are hearing-impaired and who cannot respond to the audio messages. The strobe light element may be triggered (turned on or off) by a command from the central security office and carried over the communications infrastructure. The visual alerting element may be comprised of lights of different colors in order to indicate different conditions, e.g. red for danger, yellow for caution, green for return to normal and white for attention. These colors may also be used in conjunction with audio to indicate the approach of adverse weather conditions, e.g. severe thunderstorm, tornado, hurricane.

In one embodiment a motion detector element may be integrated into the security platform. In one aspect this may be implemented through real-time digital analysis of a video camera image or through using established sonar or PIR (Infra-Red) detection methods, thus enabling observers at a central security office to be alerted to activity in the monitored environment and/or to enable the start and stop of automated video image recording, as is typical with security camera operations. The status (active/inactive) of the motion detector output may be transmitted to the central security office over the network communications infrastructure. A motion detect condition may be set to trigger automatic audio/video recording, in a recording device or memory either within the security platform or at the remote central security office.

A single communications cable or wireless signal, e.g. radio or infra-red, may carry all data traffic to and from the in-situ security clock platform.

In one embodiment of the technology described herein sufficient memory, e.g. a compact flash, secure digital module, USB thumb drive, or other suitable permanent or removable format, is included to allow the internal storage of audio and/or video recordings as captured by a microphone and/or camera, and date/time-stamped incident logs as recorded by the microprocessor. These recordings may be forwarded to the central security office via command over the data communications interface, or by manually carrying a removeable media to the central security office where it can be read in a conventional reader device.

In one embodiment of the technology described herein a wireless receiver, e.g., radio, infra-red, within the security platform is capable of receiving a “Panic Alarm” from a person within the monitored area carrying a transmitter, e.g., fob, pendant, or from a wall-mounted, button-activated transmitter; such activation to trigger A/V recording and alerts to the central security office.

In one embodiment of the technology described herein canned messages, stored within memory of the security platform may be triggered by activation of locally attached sensors or by a signal received from the central security office.

In one embodiment of the technology described herein there is provision for attachment of external sensors to the microprocessor of the Security Platform, including, but not limited to, detectors for smoke, fire, CO2, etc.

An aspect of the technology described herein is that it is directed to covert audio and visual monitoring.

Another aspect of the technology described herein is that it is directed to providing alerts and/or instructions to selected areas.

Another aspect of the technology described herein is that it may be economically produced.

These and other features and advantages of the technology described herein will be presented in more detail in the following specification of the invention and the accompanying figures, which illustrate by way of example the principles of the invention.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the technology described herein. It is important, therefore, that the claims be regarded as including such equivalent constructions insofar as they do not depart from the spirit and scope of the technology described herein.

### BRIEF DESCRIPTION OF THE SEVERAL VIEWS OF THE DRAWINGS

The technology described herein, together with further advantages thereof, may best be understood by reference to the following description taken in conjunction with the accompanying drawings in which:

FIG. 1 illustrates a surveillance device disguised as an analog clock, according to a first embodiment of the technology described herein and showing the illustrative names of surveillance elements.

FIG. 2 illustrates surveillance device disguised as an analog clock, according to a first embodiment of the technology described herein.

FIG. 3 illustrates a surveillance device disguised as a digital clock, according to a second embodiment of the technology described herein and showing the illustrative names of surveillance elements.

FIG. 4 illustrates a surveillance device disguised as a digital clock, according to a second embodiment of the technology described herein.

FIG. 5 illustrates surveillance device disguised as a digital clock, according to a third embodiment of the technology described herein and showing the illustrative names of surveillance elements.

FIG. 6 illustrates surveillance device disguised as a digital clock, according to a third embodiment of the technology described herein and showing the additional elements of multiple strobes, selected sounds recognition and selected image recognition.

FIG. 7 illustrates elements of a surveillance system using a plurality of the surveillance devices disguised as an analog clock deployed in rooms and halls of a structure, according to an embodiment of the technology described herein.

FIG. 8 illustrates elements of a surveillance system using a plurality of the surveillance devices disguised as an digital clock deployed in rooms and halls of a structure and having a single strobe light, according to an embodiment of the technology described herein.

FIG. 9 illustrates elements of a surveillance system using a plurality of the surveillance devices disguised as an digital clock deployed in rooms and halls of a structure and having multiple strobe lights, selected sound recognition and selected image recognition, according to an embodiment of the technology described herein.

### DETAILED DESCRIPTION OF THE INVENTION

The technology described herein will now be described in detail with reference to a few preferred embodiments thereof as illustrated in the accompanying drawings. In the following description, numerous specific details are set forth in order to provide a thorough understanding of the technology described herein. It will be apparent, however, to one skilled in the art, that the technology described herein may be practiced without some or all of these specific details. In other instances, well known operations have not been described in detail so not to unnecessarily obscure the technology described herein.

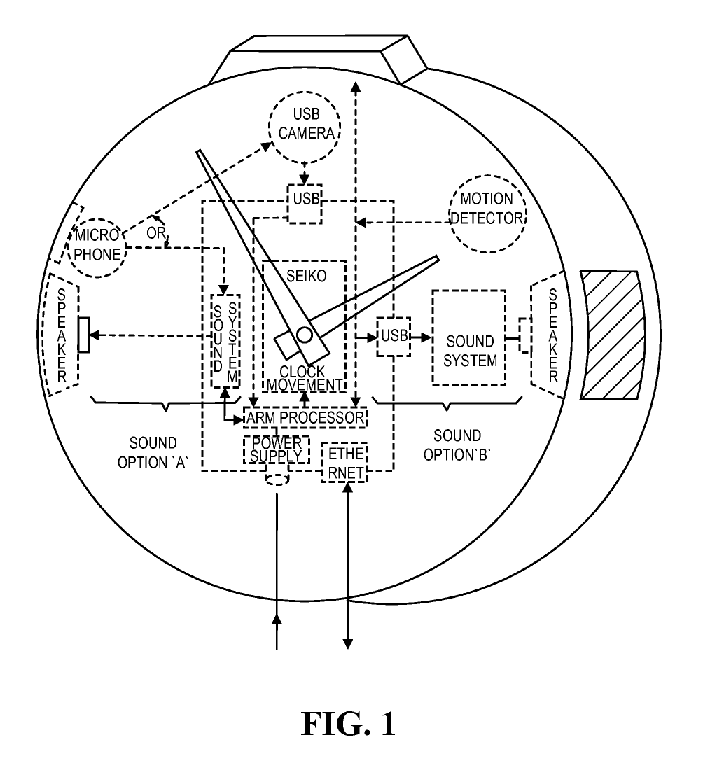

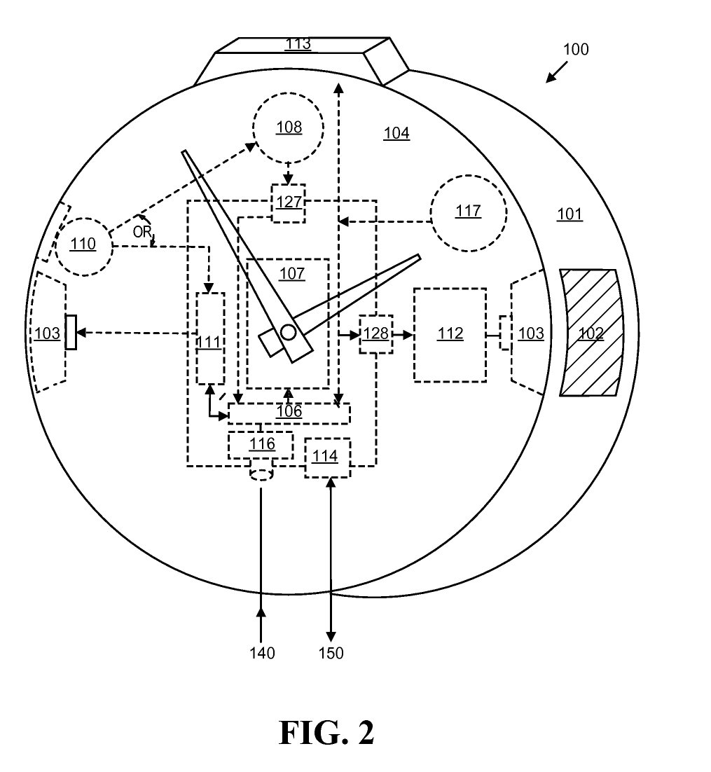

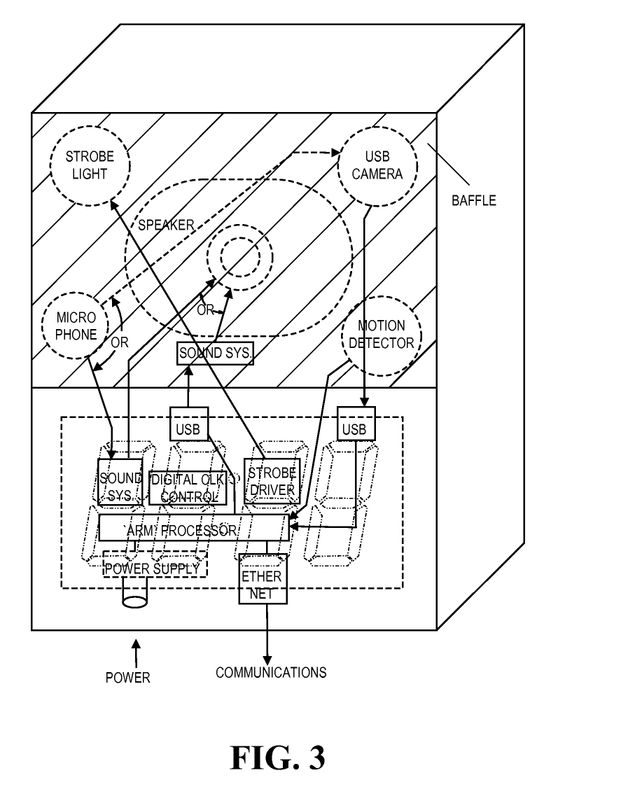

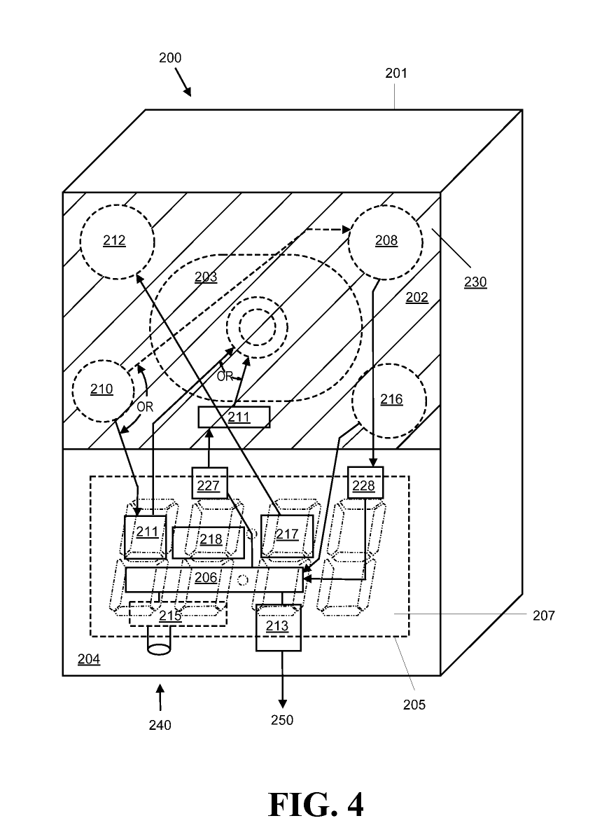

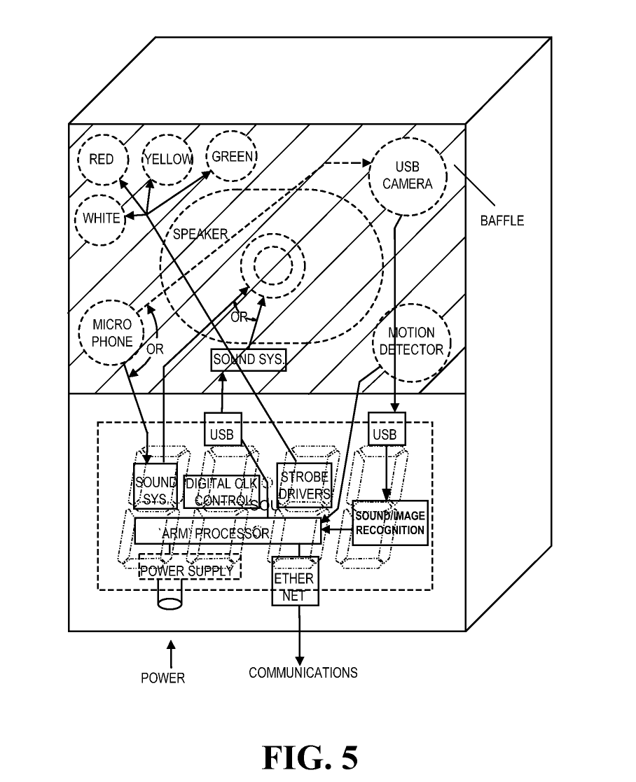

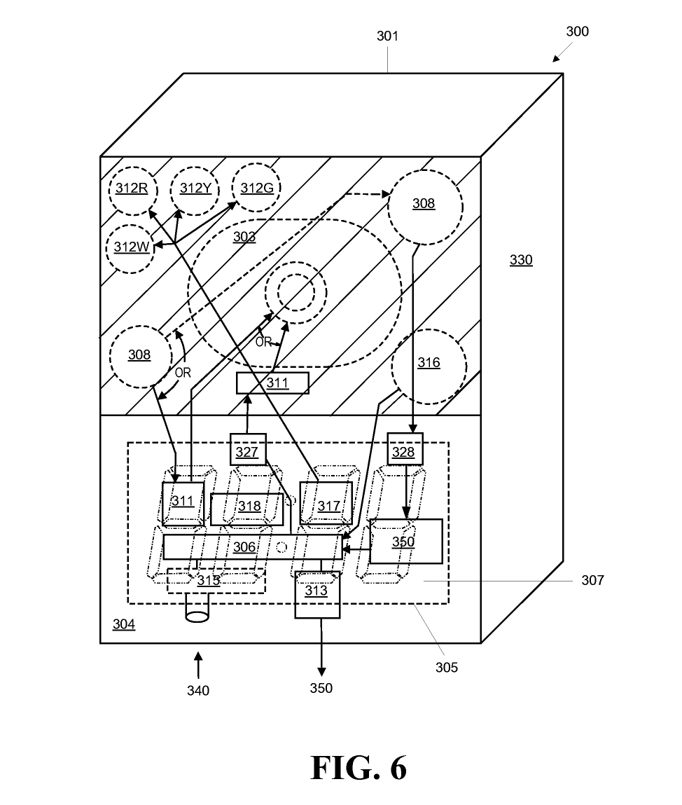

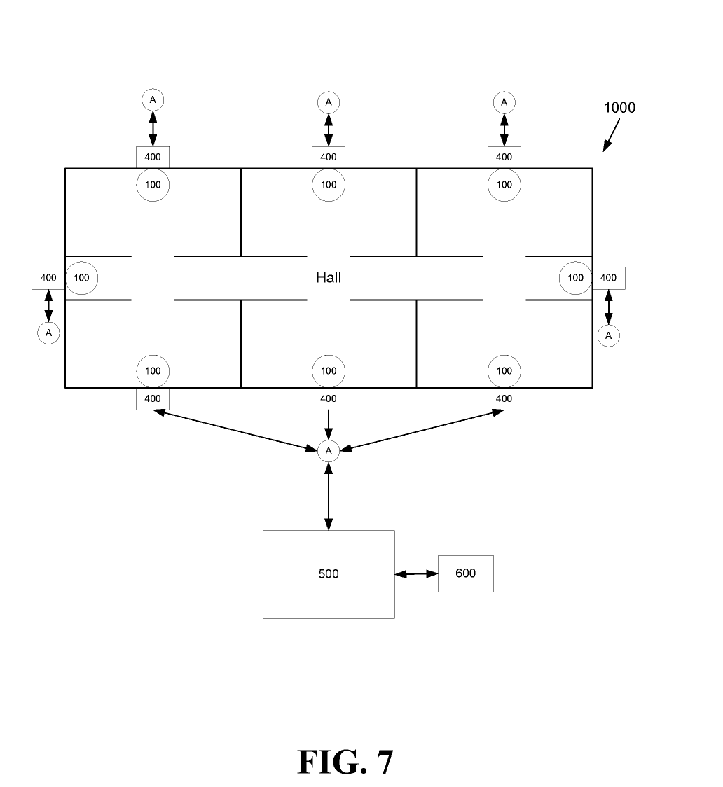

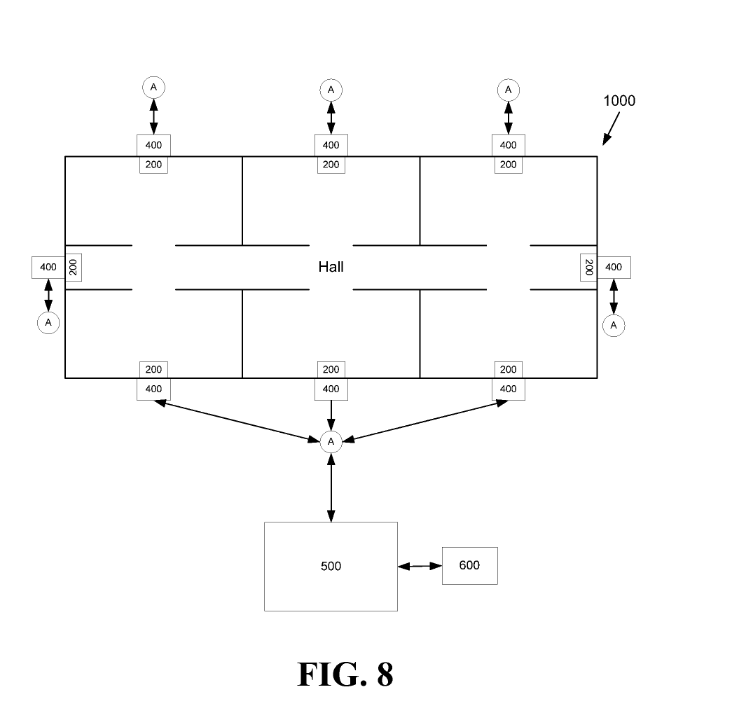

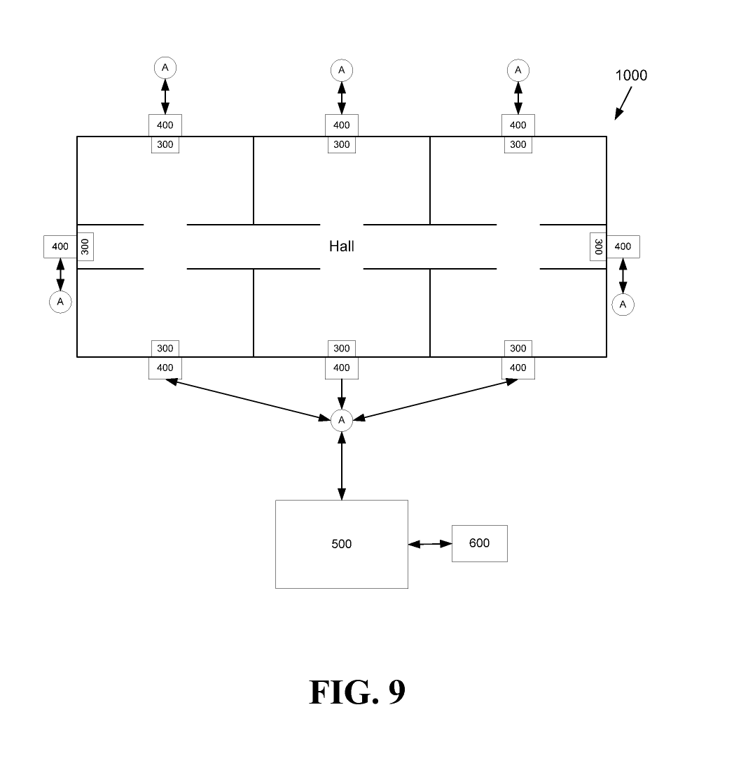

Referring now to FIG. 1 through FIG. 9 the security system 1000 is comprised of at least one of a security platform, i.e. security clock (100, 200, 300), at least one control site 500, i.e. a security office, security communications infrastructure 400, e.g. wired or wireless infrastructure, connecting the security platform(s) to the security office, and security storage-retrieval-analysis-reporting 600.

In an exemplary embodiment a security clock platform 100, 200, 300 involves the following separate subsystems integrated within the enclosure of a common wall clock:
1. a time-keeping clock movement to drive the hands of an analog clock face, or digital drivers to illuminate a digital clock display
2. a microprocessor (uP) or microcomputer (uC) to execute the bi-directional communications protocol with a central security office and to coordinate the communications of sub-systems within the security platform
3. a transceiver compatible with the communications infrastructure (wired or wireless) to receive and transmit data from/to the platform, upon the selected transport media
4. A video camera with a wide-angle lens to capture events from a monitored area. The video signal will be digitized and transmitted through the uP/uC circuits to the network transceivers.
5. An omni-directional microphone to capture the sounds of the monitored area. The audio signal will be digitized and transmitted through the uP/uC circuits to the network transceivers
6. A sound reproduction sub-system, capable of receiving a digitized audio stream through the transceivers and uP/uC circuits, providing digital-to-analog conversion (DAC) and amplification as necessary to drive an audio speaker enclosed within the platform
7. An illuminating strobe light, whose on/off condition is controlled by a signal transmitted from a central security office through the platform's communication structure.
8. A power supply to provide energy to drive the platform. This power supply may be a battery pack, or of an AC/DC or DC/DC type, converting high-voltage to low-voltage DC, or may be a DC/DC type being sourced by a power-over-ethernet (POE) infrastructure (where the communication cable also carries bulk power to remote nodes on the network
9. A motion-detector element, which may be implemented through real-time digital analysis of the video camera image or using established sonar or PIR (Infra-Red) detection methods, to indicate the occurrence of motion within its field of view. The output signal of this element is connected to the uP/uC, which forwards the status (active/inactive) to a central security office.
10. A non-discript clock case to enclose these sub-systems. Common encasements for standard analog clocks, which are applicable to the technology described herein, include, but are not limited to: 10″, 12″ and 15″ diameter round-face and square face. Wall-mount, pedestal-mount, ceiling-mount and duplex (back-to-back)-mount renditions all provide suitable positioning for the platform in the various areas into which such equipment is appropriate. These formats are provided as example, only, and are not to be considered as limiting in the scope of the invention.

One construction approach for an analog clock embodiment, security platform 100, is as follows:
1. Start with a standard clock frame consisting of
   a. a lens (glass or plastic)
   b. a dial plate (metal or plastic),
   c. a bezel (metal or plastic) to secure the lens and the dial plate and
   d. a ring 101 (metal or plastic), to give depth to the shallow cylindrical shape. (in one embodiment the bezel and ring 101 may be integrated into a single component).
2. To permit sound energy to easily pass between the clock frame and the outside environment, a screened/baffled opening 102 is made in the ring 101.
3. Behind the screened/baffled opening 102 an audio speaker 103 is situated. The audio speaker 103 may be mounted/affixed to the back-side of a dial plate 104, or to the inside of the ring 101.
4. A circuit board 105 that includes a uC/uP and other electronic components 106 is mounted behind the dial plate 104.
5. The clock movement 107 (motor, gear-box and hand-shafts) is installed between the circuit board 105 and the dial plate 104. The clock movement 107 may be affixed to either the circuit board 105 (preferred embodiment) or to the dial plate 104.
6. A small dial plate hole is made in the dial plate 104 and a small video camera 108 with an appropriately wide-angle lens is mounted behind the dial plate 104.
7. The independent video camera 108 connects to the circuit board 105 via either a conventional interface, e.g. a USB connection or an integrated video camera may connect to the uP/uC via direct mounting and circuit connection on the circuit board.
8. A small hole is made in the ring 101 and a small microphone 110 is mounted behind the dial plate 104. The microphone 110 may be optionally affixed to the ring 101, the dial plate 104, or the circuit board 105, and may be interfaced to the system through either the video camera 108 or the audio components 111 of the circuit board 105.
9. An audio sub-system may be realized in the security platform 100 through components (digital-to-analog converter, audio amplifier, digital gain control 111 included on the circuit board 105, or may be implemented as an independent audio system 112 that is connected to the circuit board 105 via a USB or similar interface.
10. A strobe light (not shown) may be included as part of the assembly. It may be attached to the outside perimeter of the ring 101, or may mounted behind the dial plate 104 provided that a translucent opening is provided to allow the illumination to project forward.
11. Communications between the circuit board 105 and a remote central security office 500 is accomplished through a network connection 114 and communications protocol. The network connection 114 may be a wired configuration or a wireless configuration (such as among those specified under the IEEE 802.xx group.
12. A motion-detector 117 element (which may be implemented through real-time digital analysis of the video camera image or by using established sonar or PIR (Infra-Red) detection methods) indicates the occurrence of motion within its field of view. If implemented using sonar or PIR methods, a transducer (not shown) is installed behind the dial plate 104 and the output signal of the transducer is connected to the uP/uC, which forwards the status (active/inactive) to the central Security Office 500.
13. Power to the circuit board 105 is applied to the voltage regulating Circuits 116 from a battery pack, through a conventional power connector, or may be integrated with the network communications interface 114, as would be manifest for USB (Universal Serial Bus) or POE (Power Over Ethernet) types.

One construction approach for an digital clock embodiment, security platform 200, is as follows:
1. An enclosure 201 of wood, metal or plastic is constructed. While a box-like shape is most typical, other shapes may also be appropriate.
2. An enclosure face upper section 202 is covered with a baffle material that permits sound and light to easily project forward from within the enclosure.
3. The enclosure face lower section 104 is typically covered with a red translucent Plexiglas/Lexan material that permits a digital clock display (typically Red LED type, but may be LCD, NCD, VFD, O-LED or other display technology 207) to show through.
4. A circuit board 205 that includes the uC/uP and other electronic components 206 is mounted behind the display 207, and may be assembled as a unit. The display driver/interface is included among the components on the circuit board 205.
5. A small hole is made in the baffle 202 and a small video camera 208 with appropriately wide-angle lens is mounted behind the baffle 202. An independent camera 208 connects to the circuit board 205 via a conventional interface (ex: USB), or an integrated camera 208 may connect to the uP/uC via direct mounting and circuit connection on the circuit board 205.
6. A small microphone 210 is mounted behind the baffle 202. The microphone 210 may be affixed to either the enclosure 201 or the circuit board 205, and may be interfaced to the system through either the video camera 208 or the audio subsystem 211 of the circuit board 205.
7. An audio sub-system 211 may be realized in the security platform through components (digital-to-analog converter, audio amplifier, digital gain control) included on the circuit board 205, or may be implemented as an independent audio system 212 that is connected to the circuit board 205 via a USB or similar interface.
8. A strobe light 213 may be included as part of the assembly, behind the baffle 202. It may be attached to the enclosure 201 or may mounted circuit board 205.
9. Communications between the circuit board 205 and a remote central security office 500 is accomplished through a network connection 214 and communications protocol. The network connection 214 may be a wired configuration or a wireless configuration (such as among those specified under the IEEE 802.xx groups).
10. A motion-detector 216 element (which may be implemented through real-time digital analysis of the video camera image or using established sonar or PIR (Infra-Red) detection methods) indicates the occurrence of motion within its field of view. If implemented using sonar or PIR methods, a transducer (not shown) is installed behind the baffle 202 and the baffle's output signal is connected to the uP/uC, which forwards the status (active/inactive) to the central security office 500.
11. Power to the circuit board 205 is applied to the voltage regulating circuits 216 from a battery pack, through a conventional power connector, or may be integrated with the network communications interface 214, as would be manifest for USB (Universal Serial Bus) or POE (Power Over Ethernet) types.

Whether the invention is realized through an analog or a digital clock configuration, the flow of data, e.g., audio and video Signals, status information and controls, between the external interface (to/from a remote security office 500) and the various sub-systems that comprise the security platform is controlled by firmware executing on the uP/uC component of the security platform. This firmware serves as arbiter of data traffic and accomplishes its mission through the execution of communication protocols individualized and conventional for each of the devices and sub-systems to which it is connected by the electronic hardware.

The firmware may be resident within non-volatile memory components of the circuit board, or may be down-loaded from the central security office or other remote server through the network interface into protected volatile memory components of the electronic system. This capability would allow remote upgrades of system performance or capability to be down-loaded into the device.

From the foregoing, it will be appreciated that, although specific embodiments of the invention have been described herein for purposes of illustration, various modifications may be made without deviating from the spirit and scope of the invention. For example, many of the features and components described above in the context of a particular security platform and system configuration can be incorporated into other configurations in accordance with other embodiments of the invention. Accordingly, the invention is not limited except by the appended claims.

1. A covert surveillance and communications device to provide real-time, remote audio and video monitoring and alerting, the device comprising:
a housing in the shape of a familiar, non-security object;
a video capturing device concealed within the housing and configured to secretly capture video data;
an audio capturing device concealed within the housing and configured to secretly capture audio data;
an audible output device concealed within the housing and configured to broadcast audio tones and verbal commands; and
a processor concealed within the housing and configured to control the video capturing device and the audio capturing device, to provide remote audio and video monitoring, and to provide audible and visual alerts and audible commands.

2. The covert surveillance and communications device to provide real-time, remote audio and video monitoring and alerting of claim 1, further comprising:
a visual display device located inconspicuously on the housing and configured to visually display an alert; and
a memory, concealed within the housing and electronically coupled to the processor, configured to store captured audio data and captured video data.

3. The covert surveillance and communications device to provide real-time, remote audio and video monitoring and alerting of claim 1, further comprising:
a removable media device configured to store captured audio data and captured video data, the removable media device being detachable from the covert surveillance and communications device for manual transport of the data.

4. The covert surveillance and communications device to provide real-time, remote audio and video monitoring and alerting of claim 1, wherein the housing is comprised of an exterior formed in the shape of a clock and an interior that comprises an instrument for measuring and displaying time.

5. The covert surveillance and communications device to provide real-time, remote audio and video monitoring and alerting of claim 1, further comprising:
a means for bidirectional network connectivity, for both transmitting and receiving data, concealed within the housing, wherein the covert surveillance and communications device is electronically connected to a central security monitoring facility.

6. The covert surveillance and communications device to provide real-time, remote audio and video monitoring and alerting of claim 5, wherein the processor is further configured to digitize the captured video data and the captured audio data, wherein the captured video and the captured audio is digitized and subsequently transmitted to the central security monitoring facility over the means for bidirectional network connectivity.

7. The covert surveillance and communications device to provide real-time, remote audio and video monitoring and alerting of claim 5, wherein the bidirectional electronic connectivity between the covert surveillance and communications device and the central security monitoring facility is wireless communications.

8. The covert surveillance and communications device to provide real-time, remote audio and video monitoring and alerting of claim 1, further comprising:
a motion detector concealed within the housing, integrated within the covert surveillance and communications device, and configured to detect motion, thereby triggering audio and/or video recording.

9. The covert surveillance and communications device to provide real-time, remote audio and video monitoring and alerting of claim 8, wherein the motion detector senses motion by a real-time digital analysis of video data captured by the video capturing device.

10. The covert surveillance and communications device to provide real-time, remote audio and video monitoring and alerting of claim 8, wherein the motion detector is configured for sonar detection and analysis to sense motion.

11. The covert surveillance and communications device to provide real-time, remote audio and video monitoring and alerting of claim 8, wherein the motion detector is configured for infrared detection and analysis to sense motion.

12. The covert surveillance and communications device to provide real-time, remote audio and video monitoring and alerting of claim 8, wherein the motion detector is monitored and controlled by a signal transmitted from a central security monitoring facility.

13. The covert surveillance and communications device to provide real-time, remote audio and video monitoring and alerting of claim 1, further comprising:
a wireless receiver concealed within the housing, integrated within the covert surveillance and communications device, and configured to receive a transmitted panic alarm, thereby triggering audio and/or video recording and transmitting an alert signal to a central security monitoring facility.

14. The covert surveillance and communications device to provide real-time, remote audio and video monitoring and alerting of claim 1, further comprising:
a power supply concealed within the housing, integrated within the covert surveillance and communications device, and configured to supply the covert surveillance and communications device with power.

15. The covert surveillance and communications device to provide real-time, remote audio and video monitoring and alerting of claim 1, wherein the video capturing device is a video camera with a wide-angle lens concealed within the housing and configured to secretly capture visual information in an area surrounding the covert surveillance and communications device.

16. The covert surveillance and communications device to provide real-time, remote audio and video monitoring and alerting of claim 1, wherein the audio capturing device concealed within the housing is an omni-directional microphone configured to secretly capture audio information in an area surrounding the covert surveillance and communications device.

17. The covert surveillance and communications device to provide real-time, remote audio and video monitoring and alerting of claim 1, further comprising:
an audio reproduction device concealed within the housing and configured to receive digital audio data from a central security monitoring facility, provide digital-to-analog conversion, and provide audio amplification;
wherein the audible output device concealed within the housing and configured to broadcast audio tones and verbal commands is a speaker to broadcast the received audio data once it is converted to analog and amplified.

18. The covert surveillance and communications device to provide real-time, remote audio and video monitoring and alerting of claim 1, wherein the visual display device comprises an illuminating strobe light, and wherein the on/off operation of the illuminating strobe light is controlled by a signal transmitted from a central security monitoring facility.

19. The covert surveillance and communications device to provide real-time, remote audio and video monitoring and alerting of claim 1, wherein the visual display device comprises a plurality of light emitting devices configured to display varying colors, wherein a combination of the varying colors comprises a communicative message, and wherein the on/off operation of the plurality of light emitting devices is controlled by a signal transmitted from a central security monitoring facility.

20. The covert surveillance and communications device to provide real-time, remote audio and video monitoring and alerting of claim 1, wherein the visual display device comprises light emitting devices controlled by a signal transmitted from a central security monitoring facility and indicative of approaching adverse weather conditions.

21. The covert surveillance and communications device to provide real-time, remote audio and video monitoring and alerting of claim 2, further comprising:
a plurality of prerecorded messages, stored within the memory of the covert surveillance and communications device, wherein one or more of the plurality of prerecorded messages is broadcast through the audible output device, as triggered by a locally attached sensor or a received signal sent by a central security monitoring facility.

22. The covert surveillance and communications device to provide real-time, remote audio and video monitoring and alerting of claim 1, further comprising:
a plurality of expansion bays integrated within the covert surveillance and communications device, and configured to accept add-on, external sensors.

23. A network security system for covert surveillance and communications, the system comprising:
a plurality of covert surveillance and communications devices, located in a plurality of diverse sites desired to be monitored and alerted for security and safety, in order to provide real-time, remote audio and video monitoring and alerting, each device comprising.
a housing in the shape of a familiar, non-security object;
a video capturing device concealed within the housing and configured to secretly capture video data;
an audio capturing device concealed within the housing and configured to secretly capture audio data;
an audible output device concealed within the housing and configured to broadcast audio tones and verbal commands;
a visual display device located inconspicuously on the housing and configured to visually display an alert; and
a processor concealed within the housing and configured to control the video capturing device and the audio capturing device, to provide remote audio and video monitoring, and to provide audible and visual alerts and audible commands; and
a memory, concealed within the housing and electronically coupled to the processor, configured to store captured audio data and captured video data; and
a means for bidirectional network connectivity, for both transmitting and receiving data, concealed within the housing, wherein each of the plurality of covert surveillance and communications devices is electronically connected to a central security monitoring facility.

24. The network security system for covert surveillance and communications of claim 23, wherein the housing in each covert surveillance and communications device is comprised of an exterior formed in the shape of a clock and an interior that comprises an instrument for measuring and displaying time.

25. The network security system for covert surveillance and communications of claim 24, wherein the plurality of covert surveillance and communications devices is synchronized to a master clock to ensure time synchronization of the network security system.

26. A security clock device for covert surveillance and communications, the device comprising:
a wall mounted clock comprising a plurality of inconspicuous ports;
a video capturing device concealed within the clock and configured to secretly capture video data through one or more of the inconspicuous ports;
an audio capturing device concealed within the clock and configured to secretly capture audio data through one or more of the inconspicuous ports;
an audible output device concealed within the clock and configured to broadcast audio tones and verbal commands through one or more of the inconspicuous ports;
a visual display device located inconspicuously on the clock and configured to visually display an alert;
a processor concealed within the clock and configured to control the video capturing device and the audio capturing device, to provide remote audio and video monitoring, and to provide audible and visual alerts and audible commands; and
a means for bidirectional network connectivity, for both transmitting and receiving data, concealed within the housing, wherein the covert surveillance and communications device is electronically connected to a central security monitoring facility.

27. The security clock device for covert surveillance and communications of claim 26, further comprising:
a memory, concealed within the housing and electronically coupled to the processor, configured to store captured audio data and captured video data.

28. The security clock device for covert surveillance and communications of claim 26, further comprising:
a removable media device configured to store captured audio data and captured video data, the removable media device being detachable from the covert surveillance and communications device for manual transport of the data.

29. The security clock device for covert surveillance and communications of claim 26, wherein the processor is further configured to digitize the captured video data and the captured audio data, wherein the captured video and the captured audio is digitized and subsequently transmitted to the central security monitoring facility over the means for bidirectional network connectivity.

30. The security clock device for covert surveillance and communications of claim 26, further comprising:
a motion detector concealed within the housing, integrated within the covert surveillance and communications device, and configured to detect motion, thereby triggering audio and/or video recording.

31. The security clock device for covert surveillance and communications of claim 26, wherein the video capturing device is a video camera with a wide-angle lens concealed within the clock and configured to secretly capture visual information in an area surrounding clock through one or more of the inconspicuous ports.

32. The security clock device for covert surveillance and communications of claim 26, wherein the wherein the audio capturing device concealed within the clock is an omni-directional microphone configured to secretly capture audio information in an area surrounding the clock through one or more of the inconspicuous ports.

33. The security clock device for covert surveillance and communications of claim 26, further comprising:
an audio reproduction device concealed within the clock and configured to receive digital audio data from a central security monitoring facility, provide digital-to-analog conversion, and provide audio amplification;
wherein the audible output device concealed within the clock and configured to broadcast audio tones and verbal commands is a speaker to broadcast the received audio data, through one or more of the inconspicuous ports, once it is converted to analog and amplified.

34. The security clock device for covert surveillance and communications of claim 26, further comprising:
a wireless receiver concealed within the housing, integrated within the covert surveillance and communications device, and configured to receive a transmitted panic alarm, thereby triggering audio and/or video recording and transmitting an alert signal to a central security monitoring facility.

35. The security clock device for covert surveillance and communications of claim 27, further comprising:
a plurality of prerecorded messages, stored within the memory of the covert surveillance and communications device, wherein one or more of the plurality of prerecorded messages is broadcast through the audible output device, as triggered by a locally attached sensor or a received signal sent by a central security monitoring facility.

36. The security clock device for covert surveillance and communications of claim 26, further comprising:
a plurality of expansion bays integrated within the covert surveillance and communications device, and configured to accept add-on, external sensors.
